(19) United States
(12) Patent Application Publication
(10) Pub. No.: US 2006/0266126 A1
(43) Pub. Date: Nov. 30, 2006

(54) Flow meter

(76) Inventors: Uwe Pohl, Uslar (DE); Uwe Mecke, Northeim (DE); Hans-Werner Schwiderski, Noerten-Hardenberg (DE)

Correspondence Address: ABB Inc.;Legal Dept. - 416, 29801 Euclia Avenue, Wickliffe, OH, 44092-1832, US

(21) Appl. No.: 11/406,937

(22) Filed: Apr. 19, 2006

(30) Foreign Application Priority Data
Apr. 22, 2005 (DE) 10 2005 018 841.9

(51) Int. Cl. G01F 1/00

(52) U.S. Cl. 73/861

(57) ABSTRACT

A flow meter has a measurement tube, in or on which the measurement system is arranged. In order to make the device more lightweight and to achieve faster installation, the measurement tube is flangeless.

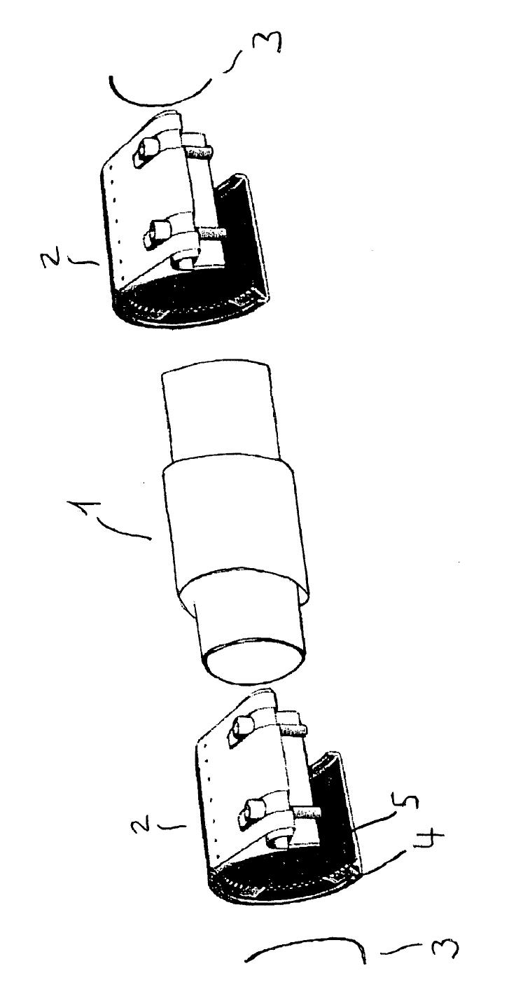

### FIELD OF THE INVENTION

This invention relates to flow meters and more particularly to a flow meter that is flangeless.

### DESCRIPTION OF THE PRIOR ART

Flow meters based on various measurement effects in which a measurement tube is provided, in or on which the measurement system is arranged, are known in the prior art. The measurement tube is intended to be fitted in a line through which the measurement medium to be recorded flows. These are generally tubes, for example pipelines in waterworks or production plants.

Flange connections are usually provided in order to install the flow meter with its measurement tube in the line system. Flow meters of known design are therefore provided with flanges on both ends of the measurement tube.

Disadvantages of this are that the flanges take up a large part of the production costs for the meter, that the flanges make a substantial contribution to the weight, and furthermore a great deal of space is required for installation.

Therefore it is desirable to eliminate the flanges from the flow meter. The present invention accomplishes this by configuring the measurement tube to eliminate the flanges.

In a further advantageous configuration, the tube can be connected to the pipeline at both ends via pinch-seal collars. In this configuration, flanges can likewise be obviated on the customer's pipeline because the pipeline ends now merely need to be fitted into the pinch-seal collars in order to connect the flow meter.

In a particular configuration, the pinch-seal collars may already be formed integrally on the ends of the measurement tube.

According to another alternative, the two ends of the measurement tube terminate bluntly and are welded by the customer to both pipeline ends of the line in which the flow rate is intended to be determined.

All of these alternatives no longer require heavy flanges on the meter and on the pipeline ends. In particular, assembly is furthermore extremely rapid in the former alternative. Pinch-seal collars have the same reliability as flange connections in respect of their leak tightness.

In another advantageous configuration of the invention, the flow meter is an inductive flow meter (IFM). This type of connection through the pipeline can be used particularly well for this widespread design of a high-accuracy flow meter.

Nevertheless, it can also be used for other flow meters such as capacitive flow meters, vortex flow meters and Coriolis flow meters.

### SUMMARY OF THE INVENTION

A flow meter having a measurement tube, in or on which a flow measurement system is arranged, wherein the measurement tube is flangeless.

### DESCRIPTION OF THE DRAWING

The only drawing figure shows an embodiment of the present invention.

### DETAILED DESCRIPTION

Referring now to the only drawing figure, that figure shows two so-called pinch-seal collars 2 which are fitted on the ends of the measurement tube 1 of a flow meter, further details of which are not however represented here, and then clamped to the ends of the measurement tube 1 and the ends of the pipeline 3.

Either the measurement tube may be configured merely without flanges and connected to the pipeline at both ends via a so-called pinch-seal collar, or the respective pinch-seal collar 2 is already arranged on each end of the measurement tube 1, in which case the pipeline is then fitted into the still unclamped open end and then clamped.

In the event that the ends of the measurement tube terminate bluntly, the pinch-seal collars represented in the figure are used.

Cuffs 4 folded inward at both ends, which grip the pipeline ends forcibly during clamping, are customary in such a pinch-seal collar. A sealing lip 5, or ring-seal lip, arranged behind then produces a correspondingly leak tight connection.

In the alternatives described above, the pinch-seal collars may already be formed integrally on the measurement tube ends.

This novel connection of flow meters can be used for all regular types of flow meters.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A flow meter having a measurement tube, in or on which a flow measurement system is arranged, wherein the measurement tube is flangeless.

2. The flow meter as claimed in claim 1, wherein the measurement tube can be connected to a pipeline at both ends by way of via pinch-seal collars.

3. The flow meter as claimed in claim 1, wherein pinch-seal collars are arranged or preassembled on both ends of the measurement tube.

4. The flow meter as claimed in claim 1, wherein the measurement tube can be connected to a pipeline by welding.

5. The flow meter as claimed in claim 1, wherein the flow meter is an inductive flow meter IFM.

6. The flow meter as claimed in claim 2, wherein the flow meter is an inductive flow meter IFM.

7. The flow meter as claimed in claim 3, wherein the flow meter is an inductive flow meter IFM.

8. The flow meter as claimed in claim 4, wherein the flow meter is an inductive flow meter IFM.

9. The flow meter as claimed in claim 1, wherein the flow meter is a capacitive flow meter.

10. The flow meter as claimed in claim 2, wherein the flow meter is a capacitive flow meter.

11. The flow meter as claimed in claim 3, wherein the flow meter is a capacitive flow meter.

12. The flow meter as claimed in claim 4, wherein the flow meter is a capacitive flow meter.

13. The flow meter as claimed in claim 1, wherein the flow meter is a vortex flow meter.

14. The flow meter as claimed in claim 2, wherein the flow meter is a vortex flow meter.

15. The flow meter as claimed in claim 3, wherein the flow meter is a vortex flow meter.

16. The flow meter as claimed in claim 4, wherein the flow meter is a vortex flow meter.

17. The flow meter as claimed in claim 1, wherein the flow meter is a Coriolis flow meter.

18. The flow meter as claimed in claim 2, wherein the flow meter is a Coriolis flow meter.

19. The flow meter as claimed in claim 3, wherein the flow meter is a Coriolis flow meter.

20. The flow meter as claimed in claim 4, wherein the flow meter is a Coriolis flow meter.
